(19) United States
(12) Patent Application Publication
(10) Pub. No.: US 2013/0332522 A1
(43) Pub. Date: Dec. 12, 2013

(54) FAST CHANNEL FOR SYSTEM MANAGEMENT

(71) Applicants: Jun Tang, Shanghai (CN); Huajun Luo, Shanghai (CN); Xichun Xu, Shanghai (CN); Jerry Liu, Shanghai (CN); Zhuocheng Xiao, Shanghai (CN); Chunhui Shi, Shanghai (CN); Sean A. Cannella, Bellevue, WA (US); David C. James, Snohomish, WA (US)

(72) Inventors: Jun Tang, Shanghai (CN); Huajun Luo, Shanghai (CN); Xichun Xu, Shanghai (CN); Jerry Liu, Shanghai (CN); Zhuocheng Xiao, Shanghai (CN); Chunhui Shi, Shanghai (CN); Sean A. Cannella, Bellevue, WA (US); David C. James, Snohomish, WA (US)

(73) Assignee: MICROSOFT CORPORATION, Redmond, WA (US)

(21) Appl. No.: 13/491,792

(22) Filed: Jun. 8, 2012

(51) Int. Cl. G06F 15/16

(52) U.S. Cl. 709/204

(57) ABSTRACT

A push-based communication channel can be established and dedicated to time-sensitive tasks in the system management space for client management. Managed clients can establish and maintain communication with a server including system management software over the channel. Subsequently, the server can send messages regarding time-sensitive/urgent tasks over the channel. In response to a message, a client can execute an action as a function of the message. In accordance with one embodiment, the client contacts the server over a pull-based communication channel to acquire a task for execution.

### BACKGROUND

System management software enables centralized and automated management of a numerous distributed computing resources including servers, desktops computers, laptop computers, mobile phones, and tablets. System management can comprise managing hardware and software inventory, software distribution, and security including anti-virus and anti-malware, among other things. System management software is designed to be highly scalable to enable use over any number of computers (e.g., hundred computers, hundreds of thousands of computers . . . ). Accordingly, a client-server infrastructure is employed, where system management software resides on a central server, as well number of management point servers in a scaled out architecture, and all managed computers, or other processor-based devices, are clients. In this scenario, each client can report to a server on some configurable interval (e.g., every hour, couple of hours . . . ) to ask whether the client is required to perform some task such as install a software update, deploy software, or report what software is currently installed. In other words, a pull-based communication is employed.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to a fast channel for system management. A dedicated and persistent communication channel is established between a client and a server in a system management, and more particularly client management, context that enables push-based communication. The server can communicate information regarding time-sensitive tasks over the persistent communication channel. In accordance with one aspect, the client, in response to notification that a task should be executed, utilizes a separate pull-based communication channel to request and acquire the task as is conventionally done. In accordance with another aspect, a task can be communicated directly over the persistent communication channel. A variety of functionality can be employed with respect to push-based communication over the persistent channel including collection of presence information, selective targeting, throttling, and waking up a client in sleep mode, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system management system.

FIG. 2 is a block diagram of a representative client-management component.

FIG. 3 is a block diagram of a representative server-management component.

FIG. 4 is an exemplary screenshot displaying presence information.

FIG. 5 illustrates an exemplary managed system.

FIG. 6 is a flow chart diagram of a server-side management method.

FIG. 7 is a flow chart diagram of a method of server-side management.

FIG. 8 is a flow chart diagram of a client-side management method.

FIG. 9 is a flow chart diagram of a method of client-side management.

FIG. 10 is a schematic block diagram illustrating a suitable operating environment for aspects of the subject disclosure.

### DETAILED DESCRIPTION

Conventionally, pull-based communication is employed in the system management space for client management (as opposed to server management where network connectivity is present and the number of servers is relatively small). Managed clients contact a server executing system management software (e.g., management point server) periodically to check whether they need to execute a management task. In large-scale environments, such as those including tens of thousands of clients, for example, when an administrator initiates a task, it can take several minutes, or even an hour, for each client to receive a task, execute the task, and report back to the server. Accordingly, administrators cannot push task execution in or near real time. This is problematic, because some tasks are mission-critical and time-sensitive (e.g., anti-virus, anti-malware). In addition, some managed clients, such as servers in data centers or clients that do not have virtual private network direct access and are not configured to be managed remotely over the Internet, have limited time reserved for management tasks. As a result, if tasks are not pushed to those clients at a specific time, the opportunity to do so may be missed.

Details below are generally directed toward a fast channel for system management. A dedicated and persistent communication channel can be established between managed clients and a server executing system management software. This channel can then be utilized to push messages to clients regarding time-sensitive tasks such as initiating execution of anti-malware and/or anti-virus software. Upon receipt of a message, a client computer can perform some action based thereon. In one instance, the client computer can immediately contact the server using the conventional pull-based channel and acquire one or more tasks for execution rather than waiting a predetermined time, such as an hour or more, prior to contacting the server. As another example, if the message includes a task, the client computer can execute that task. A variety of other functionality can be employed with respect push-based communication including collection of connection information, selective targeting, throttling, and waking up a client in sleep mode, among other things.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

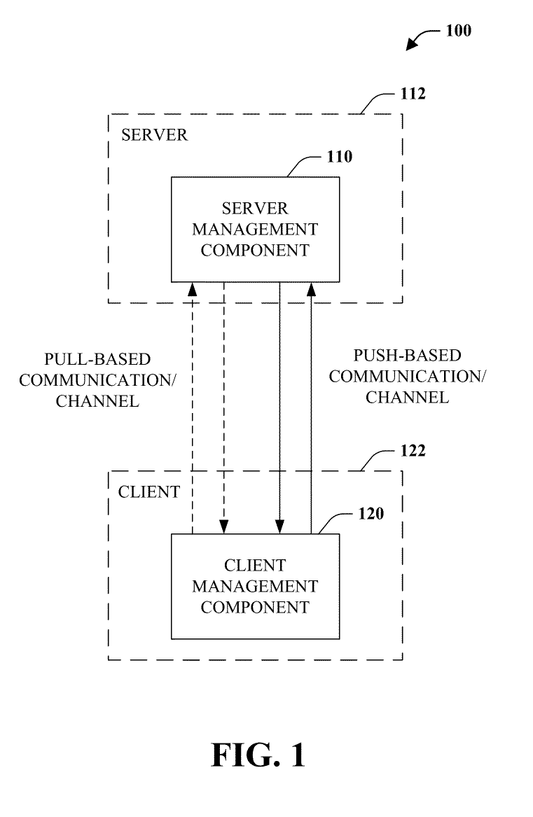

Referring initially to FIG. 1, a system management system 100 is illustrated. Similar to conventional system management software, the system 100 enables centralized and automated management of a numerous distributed computing devices including, among others, desktops computers, laptop computers, mobile phones, and tablets. For example, the system 100 can manage hardware and software inventory, software distribution, and security, among other things. The system 100 includes server management component 110 and client management component 120. The server management component 110 is configured to provide centralized management functionality executable on server 112. The client management component 120 is configured to enable management of a client 122. Any computing device that includes and executes the client management component 120 is a client 122 (sometimes referred to as a managed client) in the context of system management. For purposes of simplicity of explanation and diagrammatic clarity, a single client 122 is shown. It is to be appreciated, however, that the system 100 can include a plurality of clients, including hundreds of thousands in a large-scale environment, that operate across diverse network (and possibly geographical) topologies.

The server management component 110 and the client management component 120 can communicate in two distinct manners. First, and in accordance with conventional technology, communication can be pull based. In this scenario, the client management component 120 can connect to the sever manager by way of a communication channel, and ask whether there are any tasks that should be performed. If there are no tasks to be performed, the connection is terminated. If there are tasks to be performed, the tasks are acquired, if necessary, prior to disconnecting. Optionally, results of task execution can subsequently be communicated. Second, communication can be push based. Here, a connection/communication channel can be established and maintained between the server management component 110 and the client management component 120. Furthermore, this communication channel can be dedicated to a particular type of communication such as time-sensitive management/administrative tasks. Accordingly, a fast communication channel is provided to enable real time or near real time communication regarding time-sensitive tasks between the server management component 110 and the client management component 120.

These two communication mechanisms are complementary rather than mutually exclusive. Together real time or near real time functionality/responsiveness is provided for high priority (e.g., emergency) action (e.g., something an administrator does or an automated process) while maintaining scalability of the system. Conventional pull-based communication is designed to scale but does not support real time or near real time action. By contrast, push-based communication over or a dedicated persistent channel enables prompt action but does not scale well as a primary means of communication. Combined, however, a responsive and scalable system is provided.

In accordance with one embodiment, the push-based connection/channel can be utilized to notify the client management component 120 that at least one task is to be executed. The pull-based connection/channel can subsequently be employed to acquire more information including the task, for instance. Stated differently, rather than waiting an hour or more, for example to contact the server management component 110 as part of a periodic check, receipt of a signal on the push-based channel prompts substantially immediate connection by way of the pull-based channel. As a result, the push-based channel is not burdened with transmitting more data than necessary to prompt pull-based communication. In accordance with another embodiment, the push-based channel can include and/or identify one or more task for execution, thus eliminating the need to acquire such information utilizing the pull-based channel. For example, server management component 110 can send a message that instructs the client management component 120 to initiate a malware and/or virus scan. As another example, the client management component 120 can be provided with a script to execute (e.g., ad hoc administrator script outside normal workflow).

In theory, anything and everything can be transmitted by way of the push-based channel. However, if the push-based channel is not utilized judiciously, there is a point where the channel ceases to be fast from an operational perspective. Furthermore, the use of a persistent channel for all communications does not scale well, which is one reason why push-based communication has not heretofore been employed with respect to large-scale system management. Various mechanisms can be utilized to control push-based communication as will be described later herein.

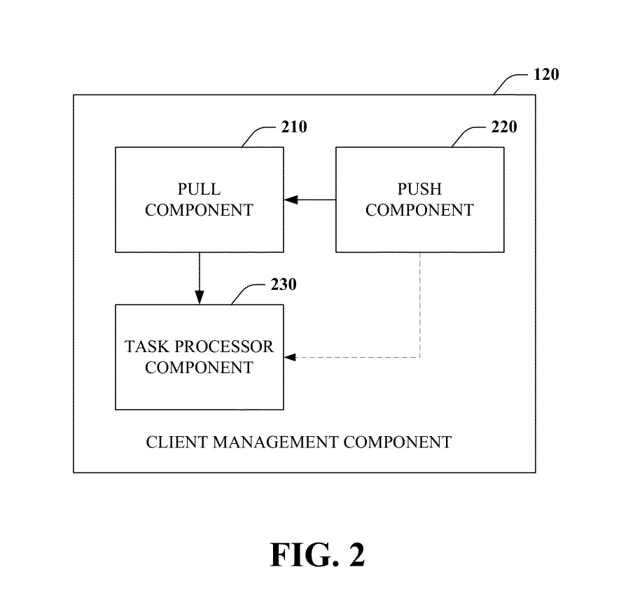

FIG. 2 depicts a representative client-management component 120. Pull component 210 is configured to enable pull-based communication with the server management component 110 of FIG. 1. The pull component 210 can utilize technology known by those of skill in the art for establishing pull-based communication in the context of system management. By contrast, push component 220 is configured to enable push-based communication. More particularly, the push component 220 can establish and maintain a connection or communication channel. In accordance with one embodiment, the push component 220 can attempt to establish a transmission control protocol (TCP) connection if the client is inside a corporate network, for example. If attempts to establish a TCP connection fail, for instance due to a proxy or firewall, a hypertext transfer protocol (HTTP) connection can be established. Similarly, if a client computer is outside a corporate network (e.g., work from home, travel . . . ), an HTTP connection can be established. More specifically, a hypertext transfer protocol secure (HTTPS (HTTP+SSL)) connection can be established, since it typically undesirable to utilize insecure connections over the Internet. Once a connection is established, the push component 220 can be configured to maintain the connection, for example by periodically sending a keep alive message regardless of whether the connection has been used or not.

In addition to establishing connections/communication channels, the pull component 210 and push component 220 can facilitate acquisition, as well as transmission of various types of data or information. For example, management tasks can be acquired and provided to task processor component 230, which is configured to execute tasks. In one embodiment, the pull component 210 can acquire information regarding a typical (e.g., non-time-sensitive) management tasks. Tasks acquired or identified with respect to a pull-based communication can be provided to the task processor component 230 for execution. The push component 220 can received messages regarding time-sensitive tasks. Subsequently, the pull component 210 can be prompted to acquire one or more time-sensitive tasks and provided them to the task processor component 230 for processing. Alternatively, the push component can acquire a task directly and provide the task to the task processor component 230 for execution. Furthermore, it should be appreciated that the pull component 210 and the push component 220 can be configured to communicate feedback associated with task execution including data or a signal that task execution succeeded or failed, among other things.

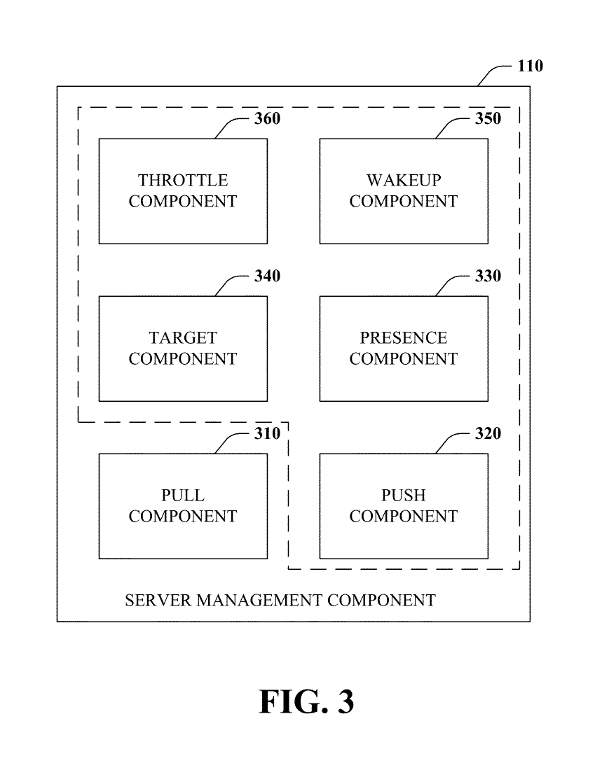

FIG. 3 illustrates a representative server-management component 110. Pull component 310 and push component 320 are server management counterparts to pull component 210 and push component 220 of the client management component 120. More particularly, the pull component 310 is configured to respond to requests for tasks and the push component 320 can provision messages regarding tasks, or tasks themselves. The server management component 110 also includes presence component 330, target component 340, wakeup component 350, and throttle component 360, which provide additional functionality with respect to push-based communication, as noted by the dotted lines surrounding the components.

The presence component 330 is configured to acquire information regarding the online presence of client computers. The presence component 330 can identify which clients are online and which clients are offline based on connection status with a server. Presence information is useful in determining when to trigger, or schedule, a task. In furtherance thereof, the presence component 330 can also be configured render or display presence information to aid an administrator in deciding when to trigger a task. By way of example, if it is desirous to distribute software to a bunch of client machines, an administrator can estimate the installation success rate. For instance, if half the client computers are offline and half are online, chances are the success rate will be around fifty-percent. A decision can be made concerning when to trigger a task based on the presence information.

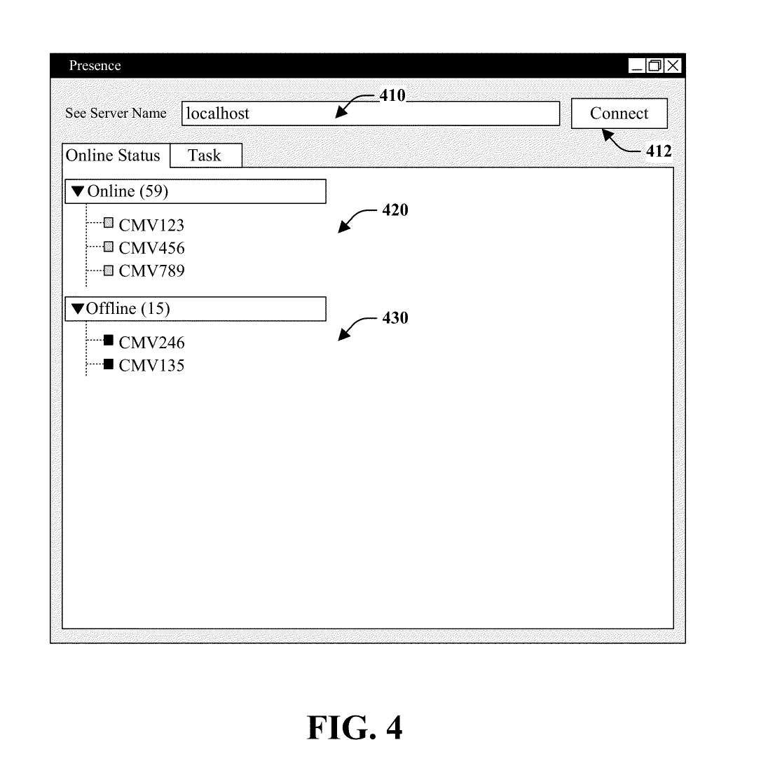

Turning attention briefly to FIG. 4, an exemplary screenshot is shown displaying presence information. Text box 410 is provided to enter a particular server name. Upon selecting button 412, a connection can be made to the server and online status information is displayed. Here, the number and identity of those client computers that are on line are displayed at 420, and the number and identity of those client computers that are offline, or not connected are displayed at 430. Of course, this is only one of a myriad of different ways to display presence information meant solely to aid clarity and understanding. Furthermore, as the number of clients increases (e.g., 25,000, 250,000), more complex views can be employed to facilitate making sense of data such as a search on client name, among other things. Accordingly, the claimed subject matter is not intended to by limited to the visualization provided.

Returning to FIG. 3, the target component 340 is configured to identify clients for which to send a task. Rather than simply broadcasting tasks to all clients, the target component 340 enables selective targeting or delivery of tasks to those clients that satisfy one or more criterion to avoid waste of bandwidth and other resources. By way of example and not limitation, a patch can be targeted for application by all clients running a particular operating system. Further, clients can be grouped into collections. For instance, a collection might comprise all managed clients in North America. More particularly, collections can be grouped statically based on unique identifiers or dynamically based on client configuration or capability (e.g., includes a particular graphic card). Accordingly, tasks can be targeted on these bases.

Where supported by a client, the wakeup component 350 is configured to wake up a client from a sleep or suspended mode. In this manner, if a client is targeted but is in sleep mode, the computing device can be woken up automatically prior to messaging the client computer, for example regarding a time-sensitive task. Similarly, where supported, the wakeup component 350 can be configured to power on a device that is in a power off mode.

The throttle component 360 is configured to control the speed at which tasks are sent to clients with respect to the persistent communication channel. In one instance, a basic static throttle of sending “X” tasks per minute can be utilized. Alternatively, more advanced throttling techniques can take a variety of factors into account such as server load, client load, or network conditions, among other things. For instance, rather than asking all client computers to contact a server at once regarding a task, thereby potentially overloading the server with requests, messages informing the client to contact the server can be staggered over time or client computers can be instructed to delay contacting the server for one minute, for example. As another example, consider clients embodied as virtual machines. In this case, there can be ten clients on the same physical host. If a malware scan, or other disk intensive task, is initiated on the ten clients at the same time, resources of the physical host will be significantly and negatively impacted. Accordingly, if such a situation can be identified, throttling can be employed to reduce the effect on the physical host, for example by initiating execution sequentially.

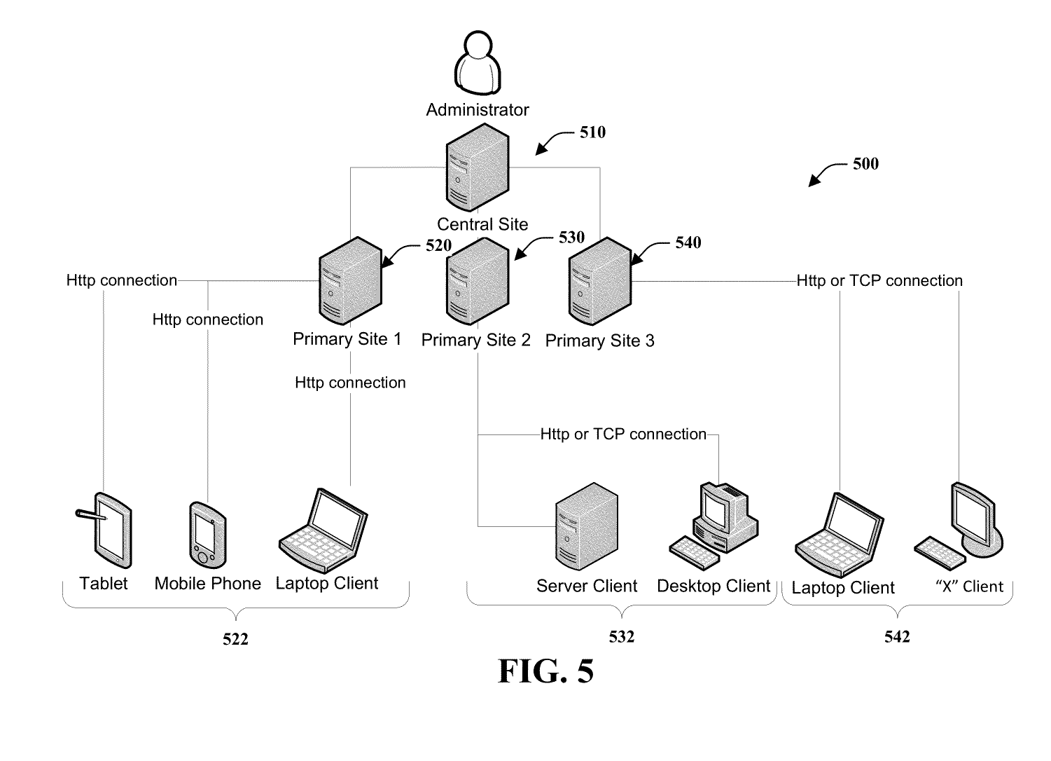

FIG. 5 illustrates an exemplary managed system 500 intended to add clarity regarding a subset of the functionality described above. Here, clients are hierarchically organized. Each client computer belongs to a site, and each hierarchy can include a central site with several primary sites. An administrator can employ the central site 510 to manage the entire system. In this scenario, there are three sites under the central site 510, namely primary sites 520, 530, and 540, perhaps corresponding to different geographical network locations. Clients can report to a corresponding primary site (or a secondary site) periodically to complete certain tasks designated by the administrator. The first client group 522 includes a tablet, mobile phone, and laptop computer, which are typically employed outside a corporate network. Accordingly, these client computers can establish a persistent connection/communication channel using HTTP or more securely HTTPS. The second client group 532 includes a server client and a desktop client, and the third client group 542 includes a laptop client and a “X” client, where “X” client refers to client employing a different operating system than other clients. Members of the second client group 532 and the third client group 542 can first attempt to establish a TCP connection and upon failure, an attempt can be made to establish a HTTP connection or in a secure environment HTTPS.

Although the persistent communication channel for push-based communication is described herein with respect to a direct connection, it is not limited thereto. By way of example, and not limitation, a relay server can be employed so that both a client computer and server can establish a feed that allows the client computer and server to communicate by way of the relay server.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the throttle component 360 can utilize such mechanism to infer an optimal sending speed with respect to various clients in light of various factors, context, and/or history, among other things.

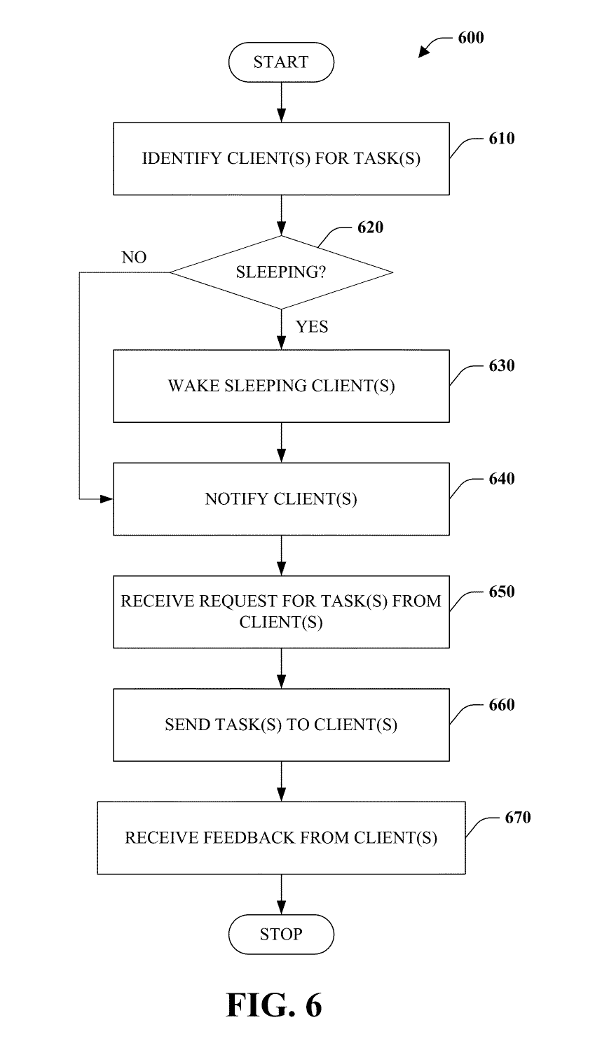

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, server-side management method 600 is illustrated. At reference numeral 610, one or more client computers/computing devices, or more simply clients, are identified as targets for one or more tasks. A determination is made at numeral 620 as to whether any of the one or more clients are in a sleep mode. If one or more of the clients are in a sleep mode (“YES”), the sleeping clients are woken at 630. Subsequently, the method can continue at 640. Alternatively, if no clients are in sleep mode (“NO”), the method proceeds directly to numeral 640, where the one or more clients are notified that a task is to be executed over a persistent communication channel dedicated to providing such notification. In accordance with one embodiment, notification can be throttled based on server load, client load, and/or network conditions, among other things. At reference 650, requests can be received for tasks over a pull-based communication channel from the notified clients. At numeral 660, tasks are sent to client computers in response to the requests over the pull-based communication channel. At reference numeral 670, feedback is received from the one or more clients such as confirmation that tasks were performed and/or other data.

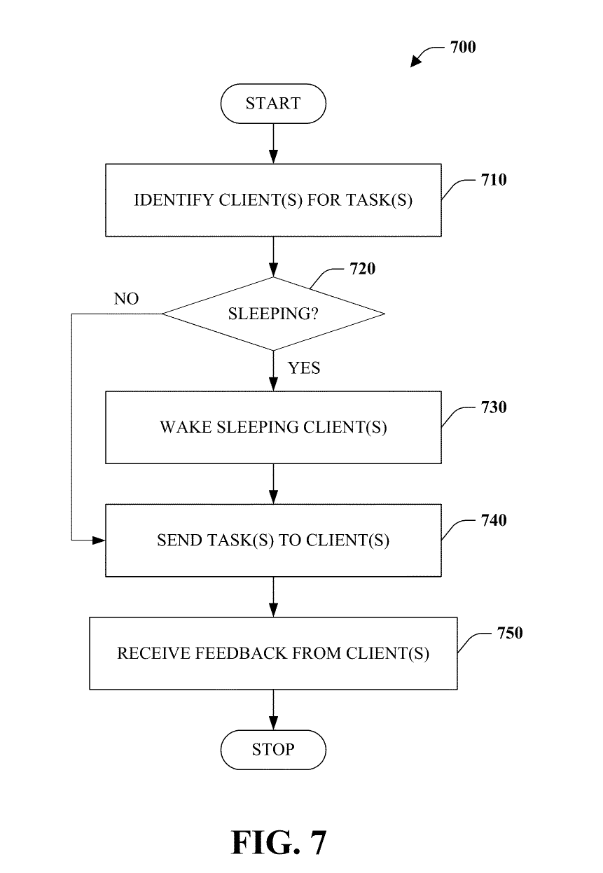

FIG. 7 depicts a method of server-side management 700. At numeral 710, one or more clients are identified as targets for one or more tasks. A determination is made at 720 concerning whether any of the target clients are in a sleep mode. If so (“YES”), the one or more sleeping clients are woke up at 730. If not (“NO”), the method continues directly to numeral 740 bypassing reference 730. At 740, one or more tasks are sent directly to the one or more target clients over a dedicated and persistent communication channel. In one instance, sending speed can be throttled in some way as a function of one or more factors, criterion, or the like. At reference numeral 750, feedback is received from the one or more target clients such as confirmation that tasks were performed, among other things.

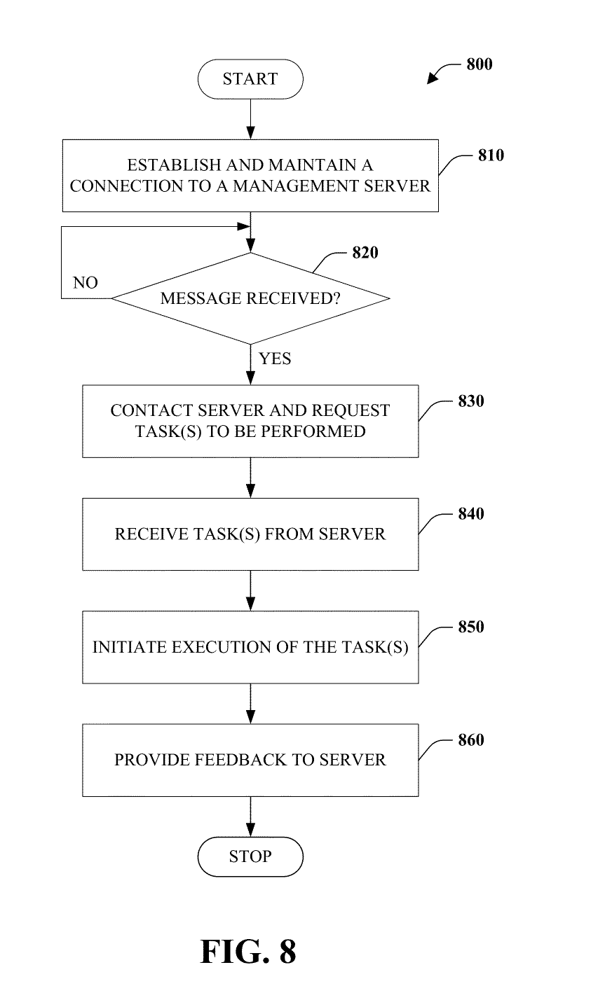

Turning attention to FIG. 8, a client-side management method 800 is illustrated. At reference numeral 810, connection to a management server is established and maintained. In other words, a persistent connection/communication channel is set up to enable push-based communication. Such a connection can be established utilizing TCP or HTTP, for example. At numeral 820, a determination is made as to whether a message has been received, or communicated, over the persistent channel. In this case, the message can notify the client that task is required to be executed urgently, or in other words ahead of its periodic check. If a message has not been received (“NO”), the method loops back to 820 to continue checking. If a message has been received (“YES”), the method proceeds to 830, where contact is made with the server to request one or more tasks to be performed. This request is made over a separate pull-based connection/communication channel as opposed to the established persistent connection/communication channel. At numeral 840, one or more tasks are received from the server, and execution of the one or more tasks is initiated at 850. At reference numeral 860 feedback is provided back to the server such as confirmation that the one or more tasks were executed successfully, or information regarding issues with tasks (e.g., failures), among other things.

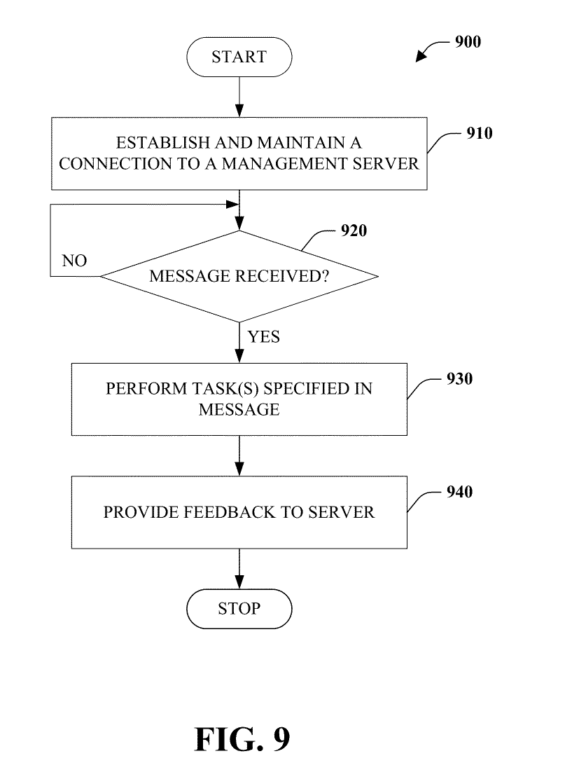

FIG. 9 is a flow chart diagram of a method of client-side management 900. At reference numeral 910, a connection is established and maintained to a management server. Stated differently, a persistent connection/communication channel is established for push-based communication. In one instance, a TCP connection can be established. In another instance, a HTTP or HTTPS connection can be established. A check is made at 920 as to whether a message has been received over the established connection. Here, the message can be a task designated for execution. If no message has been received (“NO”), the method loops at 920. Otherwise (“YES”), one or more tasks specified in the message can be executed at numeral 930. At reference numeral 940, feedback can be provided to the server, for example regarding the success or failure of task execution, among other things.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

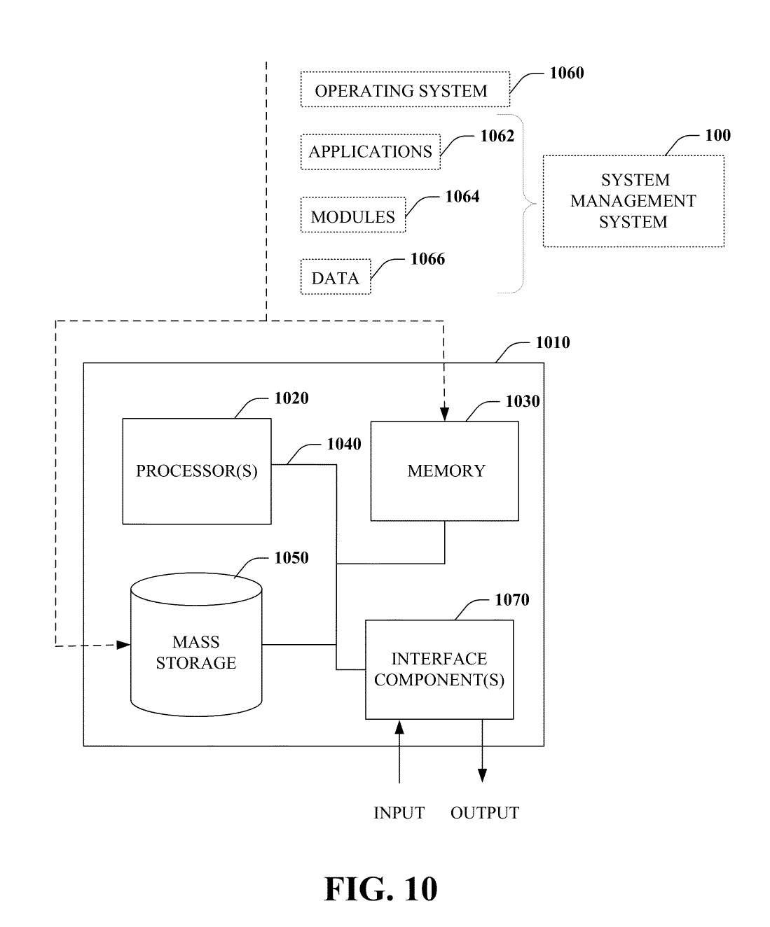

With reference to FIG. 10, illustrated is an example general-purpose computer 1010 or computing device (e.g., desktop, laptop, server, hand-held, programmable consumer or industrial electronics, set-top box, game system . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media, and removable and non-removable media. By way of example, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like medium which can be used to store the desired information and which can be accessed by the computer 1010. Further, computer storage media excludes signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the system management system 100, or portions thereof, can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system management system 100 and/or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ).

In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
initiating transmission of a message regarding a time-sensitive system management task to a client computer over a dedicated and persistent communication channel.

2. The method of claim 1 further comprises receiving a request from the client computer for the task over a different communication channel.

3. The method of claim 2 further comprises providing the task to the client computer over the different communication channel.

4. The method of claim 1, initiating transmission of an instruction that triggers one of an anti-malware or anti-virus scan on the client computer.

5. The method of claim 1, initiating transmission of a script for execution on the client computer.

6. The method of claim 1 further comprises waking up the client computer in a sleep mode prior to initiating transmission.

7. The method of claim 1 further comprises collecting information regarding online presence of the client computer prior to initiating transmission of the message.

8. The method of claim 1, initiating transmission of the message to a set of client computers that satisfy one or more criterion.

9. A method, comprising:
employing at least one processor configured to execute computer-executable instructions stored in memory to perform the following acts:
establishing a persistent communication connection, dedicated to time-sensitive management tasks, with a server running system management software.

10. The method of claim 9, further comprising performing an action in response to receipt of a message over the communication connection.

11. The method of claim 10, performing the action comprises requesting a task from the server utilizing a different communication connection.

12. The method of claim 11 further comprises executing the task acquired from the server.

13. The method of claim 9, establishing a hypertext transfer protocol secure (HTTPS) connection upon failure to establish a transmission control protocol (TCP) connection.

14. The method of claim 9, establishing the communication connection through a relay server.

15. A system, comprising:
a processor coupled to a memory, the processor configured to execute the following computer-executable components stored in the memory:
a first component, resident on a server, configured to manage a plurality of client computing devices with push-based communication and pull-based communication.

16. The system of claim 15, the push-based communication comprises a request to execute a task.

17. The system of claim 16, the task is provided in the pull-based communication.

18. The system of claim 15 further comprises second component configured to throttle push-based communication based on server load.

19. The system of claim 15 further comprises a second component configured to select targets of push-based communication based on one or more criterion.

20. The system of claim 15 further comprises a second component configured to detect online presence of one or more of the plurality of client computing devices.
